(19) United States
(12) Patent Application Publication
(10) Pub. No.: US 2009/0158608 A1
(43) Pub. Date: Jun. 25, 2009

(54) Lint Filter Device

(75) Inventors: Hartmut Schaub, Berlin (DE); Ingo Schulze, Panketal (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/085,140

(22) PCT Filed: Oct. 13, 2006
(86) PCT No.: PCT/EP2006/067388

§ 371 Date: May 16, 2008

(30) Foreign Application Priority Data
Nov. 18, 2005 (DE) 10 2005 055 180.7

(51) Int. Cl. F26B 21/00

(52) U.S. Cl. 34/80; 34/82

(57) ABSTRACT

A lint filter device for removing lint from an airflow in a tumble dryer with the airflow passing over laundry in the tumble dryer, the lint filter device being disposed across the airflow. The lint filter device includes an arrangement for trapping odors and killing germs.

The invention relates to a lint filter device for an airflow in a tumble dryer, which is arranged in such a way that it crosses the airflow, whereby the airflow blows past laundry which is in the tumble dryer.

Lint filter devices of various kinds are known from the prior art. Thus, DE 44 03 183 C2 discloses a lint filter device which is arranged in an airflow in a tumble dryer, and which can be cleaned through a mechanism linked to a loading door in the tumble dryer.

In addition, a lint filter device is known from EP 1 050 619 B1 which is also arranged in an airflow and has an endless circulating element which crosses the airflow. The lint which is carried along in the airflow is collected up in this circulating element. Laundry which is “contaminated” by unpleasant smells, such as for example smoke or the like, can be virtually cleaned in known tumble dryers by an “airing” function. By the effect of “fresh air”, unpleasant smells of this type can be removed from textiles. To do so, the laundry has air passed through it, which in a condenser dryer is then fed around the circuit in the tumble dryer and in a vented dryer is expelled into the room air. However, in the condenser dryer, smells from the laundry items get back to it again. Also, germs on the laundry, for example those which decompose bodily sweat, land there again and rapidly cause renewed formation of smells.

From EP 1 072 718 A1, a tumble dryer for this type of smell neutralization is known which has an air circulation path for a dry airflow. The air circulation path includes a rotatable drum for holding the laundry, a fan for producing the dry airflow and a heating facility for warming the dry airflow and a facility for neutralizing odorous materials and/or pathogens, which can only be effective in a region outside the drum. This facility for neutralizing odorous materials and/or pathogens can, in particular, be an activated charcoal filter. Furthermore, this facility can also be designed to destroy odorous materials and/or pathogens.

In addition, a tumble dryer and a method for removing odors from textiles are known from WO 2004/05 9070 A1. The tumble dryer has, in a region towards its rear, behind a laundry drum, a processing unit which is designed to remove odorous materials from textiles.

Furthermore, a tumble dryer with a washable filter is known from WO 01/96648 A1, where the filter consists of a flexible fibrous material and is designed in such a way that it can trap and/or decompose odorous materials. The odor filter consists of a textile material, whereby for the purpose of trapping the odorous materials the fibers of the filter are treated with particles which trap odorous materials and from which the odorous materials can be washed out again to regenerate the filter. These particles can be activated charcoal or special minerals. The filter is arranged as a separate element in an airflow of the tumble dryer, and is located downstream in the airflow's direction of flow, and at a distance from a lint filter. The odor filter can be arranged in a holding frame.

The known filter devices and tumble dryers permit only relatively inadequate odor neutralization for laundry which is “contaminated” by odors. In addition, the known devices are expensive to construct and require a relatively large amount of space.

Hence, the object of the present invention is to provide a device with which an airflow passing over an item of laundry in a tumble dryer can be better filtered out, where the device is in addition provided in a compact form and with fewer components.

This object is achieved by a device which has the features of claim 1.

In accordance with the invention, a device of this type is designed as a lint filter device for an airflow in a tumble dryer, arranged in such a way that it crosses the airflow, whereby the airflow blows past laundry items which are in the tumble dryer. The lint filter includes a section which is designed for trapping and/or decomposing odors and/or for killing germs.

Using the inventive device, it is possible to effect both filtering of lint out of the airflow and also the trapping and/or decomposing of odors and/or the killing of germs. Since only one single device, with a compact construction and fewer components, is provided for this purpose, the space requirement is also significantly reduced. Both the filtering of lint out of the airflow and also the odor neutralization and/or killing of germs can be improved by the device in accordance with the invention.

It is preferable if the section for trapping and/or decomposing odors and/or for killing germs is removably joined to the lint filter device. The cleaning, both of the section in which the lint is filtered out of the airflow and also of the section which is designed for odor neutralization or killing germs, as applicable, can then each be individually and separately carried out. This modular type of embodiment permits simple handling, which is accompanied by a cost reduction in respect also of the installation and removal and the replacement of these elements.

It is advantageous if the lint device has a frame which has a front part and a rear part, which are arranged in such a way as to form a space in between, where this space forms the section for trapping and/or decomposing odors and/or killing germs. Provision can thus be made that the lint filter device is constructed in such a way that the section is virtually formed by a space in the lint filter itself. This space, and thus also the section, can be permanently joined to the lint filter device. However, provision can also be made that the section for trapping and/or decomposing odors and/or for killing germs itself has a container-like structure which can in turn be removably affixed on or in a position provided in the lint filter device. The embodiment can thereby be realized in a flexible and individual way.

An absorbent can be introduced into the section for trapping and/or decomposing odors and/or for killing germs. The term absorbent is here to be understood as a material which has a capability for taking up odorous materials and/or germs, irrespective of how this take-up is effected. Such a take-up can be effected, for example, by adsorption or absorption. This absorbent can thus either be introduced into the container-like structure of the section, if this is in the form of a separate element, or be introduced into the space in the lint filter device which is intended to form this section for trapping and/or decomposing odors and/or killing germs.

The absorbent can advantageously have activated charcoal. Activated charcoal is particularly suited to trapping odors.

It is preferable if the absorbent has silver particles. Silver is particularly suited to killing germs, because is has a biocidal effect.

It is advantageous if provision is made that a filter gauze is arranged both on the front part and on the rear part of the frame.

The absorbent can be affixed to a carrier element, where the carrier element can be arranged on the front part and/or the rear part of the frame.

It is advantageous if the absorbent contains cyclodextrins. In addition, the absorbent can have scents.

The lint filter device for a tumble dryer can consist of a frame with a filter gauze affixed to one side. Another filter gauze can be affixed on the rear side of the frame, where the space between the filter gauzes can be filled with activated charcoal. In addition to this, the activated charcoal can advantageously also be doped with nanoparticles of silver.

Provision can also be made that the activated charcoal doped with silver particles is affixed to a carrier element or carrier material, as appropriate, which replaces at least one of the filter gauzes. A cyclodextrin, preferably also doped with silver, can be used instead of or as a supplement to the activated charcoal.

The inventive device gives the user of a tumble dryer, in addition to the usual “airing” function, the option of freshening up his textiles or items of laundry, as applicable. In addition to this, germs which are released from the laundry during airing or freshening are killed.

An exemplary embodiment of the invention is explained in more detail below by reference to a schematic drawing. The only FIGURE in this drawing shows a perspective view of a lint filter device.

The description that an airflow blows past an item of laundry located in a tumble dryer covers both the blowing over and passage through the item of laundry by the airflow.

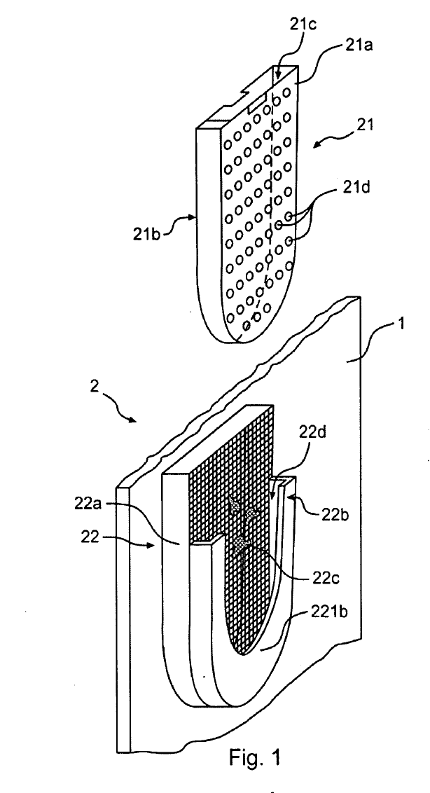

FIG. 1 shows a schematic perspective illustration of a section of a tumble dryer, which has a drum (not shown) in which laundry is laid. An airflow (not shown) is generated in the tumble dryer, this being fed through an air duct and thereby blows past the laundry in the drum. The tumble dryer can be constructed as a condenser dryer, in that the airflow is fed around an air duct which is in the form of a circulating path and, after blowing past the laundry, is demoisturized in a condenser, or as a vented dryer in that the airflow is fed in an open air duct and after blowing past the laundry is released out of the air duct.

The tumble dryer has a loading door, which is represented schematically in FIG. 1 by a section 1. Arranged on this loading door or the section 1, as applicable, is a lint filter device 2. Here, the arrangement of the lint filter device 2 is such that the airflow is across it, that is passes through it on its path in the tumble dryer.

The lint filter device 2 is constructed as a complete system, which is designed for filtering out lint carried along in the airflow and in addition for trapping and/or decomposing odors and/or for killing germs.

The lint filter device 2 is thus constructed as a compact complete system, which forms a unit and fulfils a plurality of functions.

As can be seen in the illustration in FIG. 1, the lint filter device 2 has a first section 21 which can be released from the second section 22. This first section 21 is designed for trapping and/or decomposing odors and/or for killing germs. In the exemplary embodiment shown in FIG. 1, the section 21 is designed to be container shaped, and has a front part 21a and a rear part 21b, which are arranged relative to each other in such a way that a space 21c is formed between them. As can further be seen, through-flow holes 21d are constructed both on the front part 21a and also on the rear part 21b, through which the airflow can pass. Into the space 21c is introduced an absorbent which could, for example, be activated charcoal. The activated charcoal can advantageously be doped with silver particles. However, provision can also be made that the space 21c is filled with cyclodextrins instead of or as a supplement to the activated charcoal. These cyclodextrins can also be doped with silver particles.

The U-shaped or horseshoe-shaped first section 21 can be inserted or introduced, as applicable, into the second section 22 in the lint filter device 2. Provision can also be made for the two sections 21 and 22 to interlock. Here, the second section 22 includes a wall element 22a, which is fixed onto the section 1 of the loading door. In addition, joined to this wall region 22a is an introduction region 22b, into which the first section 21 can be introduced. In addition, the second section 22 has a filter gauze 22c, which is designed to filter out lint from the airflow.

The exemplary embodiment shown in FIG. 1 can also be realized in other ways. Thus, for example, provision can be made that the first section 21 also has a filter gauze on its front part 21a and/or on its rear part 21b.

In addition to this, provision can also be made that the first section 21 is permanently joined to the second section 22. In this connection provision can be made, for example, that the introduction region 22b is not constructed, and that, rather than this introduction region 22b, the first section 21 is arranged on the second section 22.

Provision can also be made that facilities for trapping and/or decomposing odors and/or killing germs are only arranged in the introduction region 22b. In this embodiment too, the lint filter device 2 has a section which is designed for fulfilling this additional function (trapping and/or decomposing odors and/or for killing germs).

With this embodiment too, provision can be made that apart from the filter gauze 22c which is affixed virtually at the back, a second filter gauze is affixed to the front side 221b of the introduction region 22d. In the space which is thereby formed, an appropriate absorbent can then be introduced in turn into the introduction area 22b.

In all the exemplary embodiments it is possible in addition to provide that the absorbent is also doped with scents.

The invention provides a compact complete system which is constructed as one single component. This component, provided as a lint filter device, thus not only fulfils the filtering out of lint from the airflow but in addition the trapping and/or decomposing of odors and/or killing of germs.

1-10. (canceled)

11. A lint filter device for removing lint from an airflow in a tumble dryer wherein the airflow blows past laundry in the tumble dryer, with the lint filter device disposed across the airflow in a manner for air flow therethrough, the lint filter device comprising a filter element and air cleaning means associated with the filter element for cleaning air passing therethrough, with the air cleaning means including an intervention component operable to effect at least one of preventing select odors from passing downstream beyond the intervention element and suppressing select germs from passing downstream beyond the intervention element.

12. The lint filter device according to claim 11, wherein the air cleaning means is removably joined to the lint filter device.

13. The lint filter device according to claim 11 and further comprising a frame, having a front frame portion and a rear frame portion defining a frame space therebetween, said frame space being configured for removably receiving the air cleaning means.

14. The lint filter device according to claim 11 wherein the air cleaning means includes an absorbent material.

15. The lint filter device according to claim 14 wherein the absorbent material includes activated charcoal.

16. The lint filter device according to claim 14 wherein the absorbent material includes silver particles.

17. The lint filter device according to claim 13 and further comprising filter gauze material is disposed on at least one of the front frame portion and the rear frame portion.

18. The lint filter device according to claim 13 and further comprising a carrier element having an absorbent material is affixed thereto, wherein the carrier element is disposed on at least one of the front frame portion part and the rear frame portion.

19. The lint filter device according to claim 14 wherein the absorbent material includes cyclodextrins.

20. The lint filter device according to claim 14 wherein the absorbent material includes scents.
